(19) United States
(12) Patent Application Publication
(10) Pub. No.: US 2019/0065670 A1
(43) Pub. Date: Feb. 28, 2019

(54) PREDICTING DISEASE BURDEN FROM GENOME VARIANTS

(71) Applicant: Fabric Genomics, Inc., Oakland, CA (US)

(72) Inventors: Mark Yandell, Salt Lake City, UT (US); Martin Reese, Oakland, CA (US)

(21) Appl. No.: 15/922,850

(22) Filed: Mar. 15, 2018

Related U.S. Application Data
(63) Continuation of application No. PCT/US2016/052318, filed on Sep. 16, 2016.
(60) Provisional application No. 62/220,908, filed on Sep. 18, 2015.

(51) Int. Cl. G06F 19/18; G06F 19/28

(52) U.S. Cl. CPC G06F 19/18; G06F 19/28

(57) ABSTRACT

Disclosed herein are analytical methods to predict or determine a subject's phenotype burden and/or genomic load from the subject's genome sequence variants. The disclosed methods may report a dynamically ordered list of genes or genomic regions responsible for each of one or more phenotypes. Also disclosed herein are analytical methods to convert the phenotype burden and/or genomic load into a probability or risk profile or percentile for a certain phenotype or one or more phenotypes among a plurality of phenotypes, which may be compared to a reference population.

### CROSS REFERENCE

This application claims priority to U.S. Provisional Patent Application Ser. No. 62/220,908, filed Sep. 18, 2015, which is entirely incorporated herein by reference.

### STATEMENT AS TO FEDERALLY SPONSORED RESEARCH

This invention was made with the support of the United States government under Contract number R44HG00657 by NIH.

### BACKGROUND

Manual analysis of personal genome sequences is a massive, labor-intensive task. Although much progress is being made in DNA sequencing, read alignment and variant calling, little software yet exists for the automated analysis of personal genome sequences. Indeed, the ability to automatically annotate variants, to combine data from multiple projects, and to recover subsets of annotated variants for diverse downstream analyses is becoming a critical analysis bottleneck.

Researchers are now faced with multiple whole genome sequences, each of which has been estimated to contain around 4 million variants. This creates a need to efficiently prioritize variants so as to efficiently allocate resources for further downstream analysis, such as external sequence validation, additional biochemical validation experiments, further target validation such as that performed routinely in a typical Biotech/Pharma discovery effort, or in general additional variant validation. Such relevant variants are also called phenotype-causing genetic variants.

### SUMMARY

In light of at least some of the limitations of current methods and systems, recognized herein is the need for improved methods and systems for genomic analysis.

The present disclosure provides methods and systems that can automatically annotate variants, combine data from multiple projects, and recover subsets of annotated variants for diverse downstream analyses. Methods and systems provided herein can efficiently prioritize variants so as to efficiently and effectively allocate resources for further downstream analysis, such as external sequence validation, additional biochemical validation experiments, further target validation, and additional variant validation.

The present disclosure provides methods and systems that combine or aggregate (e.g., sum) two or more variants and two or more genes that affect one or more phenotypes to provide a risk score for each phenotype.

An aspect of the present disclosure provides a method of prioritizing two or more variants based on a risk score of each of two or more phenotypes/diseases, comprising: (a) obtaining one or more genome sequence variants from two or more genes or genomic regions of a biological sample of a subject; (b) determining, using a programmed computer processor, a risk score for each of the two or more phenotypes by: (i) determining a phenotype association score for each gene or genomic region in the one or more genes or genomic regions to provide a plurality of phenotype association scores; (ii) combining the plurality of phenotype association scores to provide the risk score for each of the two or more phenotypes; (c) prioritizing the two or more phenotypes based on the risk score for each of the two or more phenotypes, thereby providing a list of prioritized phenotypes; and (d) providing a report comprising the list of prioritized phenotypes. In one embodiment, the method of prioritizing two or more phenotypes further comprises (e) providing for at least a subset of phenotypes from the list of prioritized phenotypes a dynamically ranked list of genes or genomic regions associated with each phenotype in the subset of phenotypes.

One embodiment provides a method wherein the dynamically ranked list is ordered based on the phenotype association score. Another embodiment provides a method, wherein the subset of phenotypes comprises phenotypes with risk scores indicating an association above a cutoff. In yet another embodiment, the one or more genome sequence variants are determined by high-throughput sequencing. Another embodiment provides a method wherein the high-throughput sequencing comprises whole genome sequencing. Yet another embodiment provides a method wherein the high-throughput sequencing comprises exome sequencing.

Another embodiment provides a method wherein the high-throughput sequencing comprises sequencing disease-specific markers. An embodiment provides a method wherein the obtaining comprises mapping sequencing reads from the high-throughput sequencing to a reference genome. An embodiment provides a method wherein the reference genome is a human genome. An embodiment provides a method wherein the two or more phenotypes comprise a disease, a term from phenotype ontologies, a term from disease ontologies, or any combination thereof.

In some embodiments, the phenotype association score is based at least in part on a prioritization score from a variant prioritization tool. An embodiment provides a method wherein the variant prioritization tool calculates the prioritization score based at least in part on (i) a frequency of genome sequence variants in the given gene or genomic region in a population with the phenotype and (ii) a frequency of genome sequence variants in the given gene or genomic region in a population lacking the phenotype. Yet another embodiment provides a method wherein the prioritization score is based on sequence characterization of the given gene or genomic region. Yet another embodiment provides a method wherein the sequence characterization comprises one or more characterizations selected from the group consisting of gene, exon, intron, splice site, amino acid coding sequences, promoters, noncoding RNAs, and untranslated regions. Another embodiment provides a method wherein the phenotype association score is generated at in least in part using Variant Annotation, Analysis and Search Tool (VAAST); pedigree-Variant Annotation, Analysis, and Search Tool (pVAAST); Sorting Intolerant from Tolerant (SIFT); Variant Annotation, Analysis and Search Tool (VAAST); pedigree-Variant Annotation, Analysis, and Search Tool (pVAAST); Sorting Intolerant from Tolerant (SIFT); Annotate Variation (ANNOVAR); burden-tests, and sequence conservation tools.

An embodiment provides a method wherein the phenotype association score is based on knowledge resident in one or more biomedical ontologies. An embodiment provides a method wherein the phenotype association score is at least in part based on methods from the Phenotype Driven Variant Ontological Re-ranking tool (PHEVOR). Yet another embodiment provides a method wherein the one or more biomedical ontologies includes one or more of the Gene Ontology, Disease Ontology, Human Phenotype Ontology and Mammalian Phenotype Ontology. Yet another embodiment provides a method wherein the knowledge resident in the one or more biomedical ontologies is incorporated into the phenotype association score by a summing procedure, and wherein the summing procedure is ontological propagation and one or more seed nodes are identified using each of the two or more phenotypes.

An embodiment provides a method wherein the one or more seed nodes are identified using a plurality of phenotype descriptions associated with each of the two or more phenotypes. An embodiment provides a method wherein the seed nodes in the biomedical ontologies are identified, each seed node is assigned a value greater than zero, and this information is propagated across the biomedical ontologies. In some embodiments, the method further comprises proceeding from each seed node toward its neighboring nodes, wherein when an edge to a neighboring node is traversed, a current value of a previous node is divided by a constant value. An embodiment provides a method wherein in the summing procedure, upon completion of propagation, each node's value is renormalized to a value between zero and one by dividing by a sum of all nodes' values in the biomedical ontologies. In some embodiments, the method further comprises traversal of the biomedical ontologies, propagation of information across the biomedical ontologies and combination of one or more results of transversal and propagation to produce a gene score which embodies a prior-likelihood that a given gene or genomic region has an association with a user described phenotype or gene function. In some embodiments the method further comprises using the programmed computer processor to calculate the phenotype association score (D_{g}) for the given gene or genomic region, wherein D_{g}=(1−V_{g})×N_{g}, wherein N_{g} is a renormalized gene or genomic region sum score derived from ontological propagation, and V_{g} is a percentile rank of the given gene or genomic region provided by the variant prioritization tool, or in some cases the p-value provided by VAAST. In some embodiments, the method further comprises calculating a healthy association score (H_{g}) summarizing a weight of evidence that a gene is not involved with an illness of an individual, wherein, H_{g}=V_{g}×(1−N_{g}). In some embodiments, the method further comprises calculating the phenotype association score, S_{g}, as a log₁₀ ratio of disease association score (D_{g}) and the healthy association score (H_{g}), wherein S_{g}=log₁₀ D_{g}/H_{g}. In some embodiments, the method further comprises determining the risk score by summing S_{g} of each gene or genomic region for each of the two or more phenotypes. In some embodiments, the method further comprises determining the risk score by determining a posterior probability that the genes or genomic regions as a whole are in a disease state and a posterior probability that the genes or genomic regions as a whole are in a healthy state.

In some embodiments of methods provided herein, the probability that the genes or genomic regions as a whole are in a disease state is determined by the recursion pDᵢ=

$$\{ \begin{matrix}i = 1 \\ i = n\end{matrix} \frac{{D}_{i} * {pD}_{i - 1}}{{D}_{i} * {pD}_{i - 1} + ( 1 - {D}_{i} ) * ( 1 - {pD}_{i - 1} )} , {pD}_{0} = 0.5$$

and the probability that the genes or genomic regions as a whole are in the healthy state is determined by the recursion

$${pH}_{i} = \{ \begin{matrix}i = 1 \\ i = n\end{matrix} \frac{{H}_{i} * {pH}_{i - 1}}{{H}_{i} * {pH}_{i - 1} + ( 1 - {H}_{i} ) * ( 1 - {pH}_{i - 1} )} , {pH}_{0} = 0.5 .$$

The probability determined may be a posterior or conditional probability. The probabilities pD and pH may provide a composite score indicative or whether a gene panel is in a disease or healthy state, or some combination thereof. An embodiment provides a method wherein the risk score is related to a ratio of the conditional or posterior probability that the genes or genomic regions as a whole are in the healthy state and the conditional or posterior probability that the genes or genomic regions as a whole are in the disease state. In some embodiments, the risk score is determined by log₁₀

$$\frac{{pD}_{n}}{{pH}_{n}} .$$

Another embodiment provides a method wherein the risk score allows the comparison of risk scores of the two or more phenotypes when they have no genes or genomic regions associated with the two or more phenotypes in common. Another embodiment provides a method wherein the risk score allows the comparison of risk scores of the two or more phenotypes when the phenotypes are associated with different numbers genes or genomic regions with phenotype association scores above a cutoff. Another embodiment provides a method wherein the risk score is normalized to an expected risk score to provide a normalized risk score. Another embodiment provides a method wherein the expected risk score is determined by permuting the phenotype association scores of the genes or genomic regions. Another embodiment provides a method wherein the normalized risk score is used to compare risk scores between individuals of different genetic backgrounds. The risk score may be a genomic risk score.

An embodiment provides a method wherein the normalized risk is used to rank risk scores of different phenotypes. Another embodiment provides a method wherein a set of normalized risk scores are determined for a cohort of healthy individuals to provide a population distribution of normalized risk scores. Another embodiment provides a method wherein the normalized risk score of the subject is compared to the population distribution of normalized risk scores to determine the deviation of the subject's risk score from the population distribution of normalized risk scores. Another embodiment provides a method wherein the deviation is determined relative to the mean of the population distribution of normalized risk scores. In some embodiments, the normalized risk score is calculated for each individual in a cohort of individuals with a given phenotype and a cohort of individuals without a given phenotype.

In some embodiments, a distribution of normalized risk scores for the cohort of individuals with the given phenotype is compared to the cohort of individuals without the given phenotype. Another embodiment provides a method wherein the different genetic backgrounds are different ethnicities. Another embodiment provides a method wherein the report comprises only genes or genomic regions with risk scores greater than zero. In some embodiments the method further comprises providing for at least a subset of phenotypes from the list of prioritized phenotypes a dynamically ranked list of genes or genomic regions associated with each phenotype in the subset of phenotypes, wherein the genes or genomic regions are prioritized based on S_{g}, for each phenotype in the subset of phenotypes.

In some embodiments, the two or more phenotypes are common diseases. Another embodiment provides methods wherein the two or more phenotypes are rare diseases.

In some embodiments, determining the phenotype association score further comprises including an interaction term, wherein a presence of one or more genome sequence variants in a first gene or genomic region in conjunction with a presence of one or more genome sequence variants in a second gene or genomic region provides a risk score that is different from the sum of the risk scores of genome sequence variants in the first gene or genomic region and the second gene or genomic region alone. In some embodiments, the interaction between the presence of one or more genome sequence variants in a first gene or genomic region with the presence of one or more genome sequence variants in the second gene or genomic region causes the subject to have an increased risk score for each of the two or more phenotypes. In some embodiments, the interaction between the presence of one or more genome sequence variants in a first gene or genomic region with the presence of one or more genome sequence variants in the second gene or genomic region causes the subject to have an decreased risk score for each of the two or more phenotypes.

In some embodiments, the report is an electronic report. In some embodiments, the electronic report is provided on a user interface with graphical elements that correspond to the prioritized phenotypes. In some embodiments the method further comprises transmitting the electronic report to a user over a network.

Another aspect of the present disclosure provides a computer system for prioritizing two or more phenotypes based on a risk score of each of the two or more phenotypes, comprising: computer memory comprising one or more genome sequence variants from one or more genes or genomic regions of a biological sample of a subject; and one or more computer processors operatively coupled to the computer memory, wherein the one or more computer processors are individually or collectively programmed to: (a) determine a risk score for each of the two or more phenotypes by: (i) determining a phenotype association score for each gene or genomic region in the one or more genes or genomic regions to provide a plurality of phenotype association scores; (ii) combining the plurality of phenotype association scores to provide the risk score for each of the two or more phenotypes; (b) prioritize the two or more phenotypes based on the risk score for each of the two or more phenotypes, thereby providing a list of prioritized phenotypes; and (c) provide a report comprising the list of prioritized phenotypes.

In some embodiments, the computer system further comprises an electronic display with a user interface with graphical elements that correspond to the prioritized phenotypes.

Another aspect of the present disclosure provides a non-transitory computer readable medium comprising machine-executable code that, upon execution by one or more computer processors, implements a method of prioritizing two or more phenotypes based on a risk score of each of the two or more phenotypes, the method comprising: (a) obtaining one or more genome sequence variants from one or more genes or genomic regions of a biological sample of a subject; (b) determining, using a programmed computer processor, a risk score for each of the two or more phenotypes by: (i) determining a phenotype association score for each gene or genomic region in the one or more genes or genomic regions to provide a plurality of phenotype association scores; (ii) combining the plurality of phenotype association scores to provide the risk score for each of the two or more phenotypes; (c) prioritizing the two or more phenotypes based on the risk score for each of the two or more phenotypes, thereby providing a list of prioritized phenotypes; and (d) providing a report comprising the list of prioritized phenotypes.

In some embodiments, the output provides a report comprising the risk score for each of the one or more phenotypes. In some embodiments, the report is an electronic report. In some embodiments, the report is provided on a user interface with graphical elements that correspond to the prioritized phenotypes. Some embodiments further comprise transmitting the electronic report to a user over a network. In some embodiments, the report comprises only genes or genomic regions with risk scores greater than zero.

Some embodiments further comprise providing a therapeutic intervention subsequent to outputting the list of prioritized phenotypes. In some embodiments, the therapeutic invention comprises treating or monitoring the subject for at least a subset of the one or more phenotypes. In some embodiments, the one or more phenotypes comprise a disease, and wherein the therapeutic invention comprises treating or monitoring the subject for the disease. In some embodiments, the disease is a genetic disease. In some embodiments, the risk score is determined for each of the two or more phenotypes.

Yet another aspect of the present disclosure provides a method of combining two or more genome sequence variants to output a risk score for one or more phenotypes, comprising: (a) obtaining two or more genome sequence variants from two or more genes or genomic regions of a biological sample of a subject; (b) determining, using a programmed computer processor, a risk score for each of the one or more phenotypes by: (i) determining a phenotype association score for each gene or genomic region in the two or more genes or genomic regions comprising the two or more genome sequence variants to provide a plurality of phenotype association scores; (ii) combining the plurality of phenotype association scores to provide the risk score for the one or more phenotypes; and (c) outputting the risk score for each of the one or more phenotypes. In some embodiments, the method may further comprise (d) prioritizing the two or more genome sequence variants based on the risk score for each of the one or more phenotypes, thereby providing a list of prioritized genome sequence variants. In some embodiments, the prioritized two or more genome sequence variants are outputted in a list.

In some embodiments, the two or more genome sequence variants are obtained by high-throughput sequencing. In some embodiments, the high-throughput sequencing comprises whole genome sequencing. In some embodiments, the high-throughput sequencing comprises exome sequencing. In some embodiments, the high-throughput sequencing comprises sequencing disease-specific markers.

In some embodiments, obtaining two or more genome sequence variants from two or more genes or genomic regions of a biological sample of a subject comprises mapping sequencing reads from the high-throughput sequencing to a reference genome. In some embodiments, the reference genome is a human genome.

In some embodiments, the one or more phenotypes comprise a disease, a term from phenotype ontologies, a term from disease ontologies, or any combination thereof. In some embodiments, the phenotype association score is based at least in part on a prioritization score from a variant prioritization tool. In some embodiments, the variant prioritization tool calculates the prioritization score based at least in part on (i) a frequency of genome sequence variants in a given gene or genomic region in a population with the phenotype and (ii) a frequency of genome sequence variants in the given gene or genomic region in a population lacking the phenotype. In some embodiments, the prioritization score is based on sequence characterization of the given gene or genomic region. In some embodiments, the sequence characterization comprises one or more characterizations selected from the group consisting of gene, exon, intron, splice site, amino acid coding sequences, promoters, noncoding RNAs, and untranslated regions.

In some embodiments, the phenotype association score is generated at in least in part using Variant Annotation, Analysis and Search Tool (VAAST); pedigree-Variant Annotation, Analysis, and Search Tool (pVAAST); Sorting Intolerant from Tolerant (SIFT); Variant Annotation, Analysis and Search Tool (VAAST); pedigree-Variant Annotation, Analysis, and Search Tool (pVAAST); Sorting Intolerant from Tolerant (SIFT); Annotate Variation (ANNOVAR); burden-tests, and sequence conservation tools. In some embodiments, the phenotype association score is based on knowledge resident in one or more biomedical ontologies. In some embodiments, the phenotype association score is at least in part based on methods from the Phenotype Driven Variant Ontological Re-ranking tool (PHEVOR).

In yet other embodiments, the one or more biomedical ontologies include one or more of the Gene Ontology, Disease Ontology, Human Phenotype Ontology and Mammalian Phenotype Ontology. In some embodiments, the knowledge resident in the one or more biomedical ontologies is incorporated into the phenotype association score by a summing procedure, and wherein the summing procedure is ontological propagation and one or more seed nodes are identified using each of the two or more phenotypes. In some embodiments, the one or more seed nodes are identified using a plurality of phenotype descriptions associated with each of the two or more phenotypes. In some embodiments, the seed nodes in the biomedical ontologies are identified, each seed node is assigned a value greater than zero, and this information is propagated across the biomedical ontologies. Some embodiments further comprise proceeding from each seed node toward its neighboring nodes, wherein when an edge to a neighboring node is traversed, a current value of a previous node is divided by a constant value. In some embodiments, the summing procedure, upon completion of propagation, each node's value is renormalized to a value between zero and one by dividing by a sum of all nodes' values in the biomedical ontologies. Some embodiments further comprise traversing biomedical ontologies, propagation of information across the biomedical ontologies and combination of one or more results of transversal and propagation to produce a gene score which embodies a prior-likelihood that a given gene or genomic region has an association with a user described phenotype or gene function.

One or more embodiments may further comprise using the programmed computer processor to calculate the phenotype association score (D_{g}) for the given gene or genomic region, wherein D_{g}=(1−V_{g})×N_{g}, wherein N_{g} is a renormalized gene or genomic region sum score derived from ontological propagation, and V_{g} is a percentile rank of the given gene or genomic region provided by the variant prioritization tool. Some embodiments may further comprise calculating a healthy association score (H_{g}) summarizing a weight of evidence that a gene is not involved with an illness of an individual, wherein, H_{g}=V_{g}×(1−N_{g}). Some embodiments may further comprise calculating the phenotype association score, S_{g}, as a log₁₀ ratio of disease association score (D_{g}) and the healthy association score (H_{g}), wherein S_{g}=log₁₀ D_{g}/H_{g}.

Additional embodiments may further comprise determining the risk score by combining S_{g} of each gene or genomic region for each of the two or more phenotypes. Some embodiments may further comprise determining the risk score by determining a combined score indicative of a probability that the genes or genomic regions as a whole are in a disease state and a combined score indicative of a probability that the genes or genomic regions as a whole are in a healthy state. In some embodiments, the combined score indicative of a probability that the genes or genomic regions as a whole are in a disease state is determined by: pDᵢ=

$$\{ \begin{matrix}i = 1 \\ i = n\end{matrix} \frac{{D}_{i} * {pD}_{i - 1}}{{D}_{i} * {pD}_{i - 1} + ( 1 - {D}_{i} ) * ( 1 - {pD}_{i - 1} )} , {pD}_{0} = 0.5$$

and the combined score indicative of a probability that the genes or genomic regions as a whole are in the healthy state is determined by pHᵢ=

$${pH}_{i} = \{ \begin{matrix}i = 1 \\ i = n\end{matrix} \frac{{H}_{i} * {pH}_{i - 1}}{{H}_{i} * {pH}_{i - 1} + ( 1 - {H}_{i} ) * ( 1 - {pH}_{i - 1} )} , {pH}_{0} = 0.5 .$$

In some embodiments, the risk score is related to a ratio of the combined score indicative of a probability that the genes or genomic regions as a whole are in the healthy state and the combined score indicative of a probability that the genes or genomic regions as a whole are in the disease state. In some embodiments, the risk score is determined by log₁₀

$$\frac{{pD}_{n}}{{pH}_{n}} .$$

In various embodiments, the risk score allows the comparison of risk scores of two or more phenotypes when the phenotypes are associated with different numbers genes or genomic regions with phenotype association scores above a cutoff.

In some embodiments, the risk score is normalized to an expected risk score to provide a normalized risk score. In some embodiments, the expected risk score is determined by permuting the phenotype association scores of the genes or genomic regions. In some embodiments, the normalized risk score is used to compare risk scores between individuals of different genetic backgrounds. In some embodiments, the normalized risk is used to rank risk scores of different phenotypes. In some embodiments, the set of normalized risk scores are determined for a cohort of healthy individuals to provide a population distribution of normalized risk scores. In some embodiments, the normalized risk score of the subject is compared to the population distribution of normalized risk scores to determine a deviation of the subject's risk score from the population distribution of normalized risk scores. In some embodiments, the deviation is determined relative to a mean of the population distribution of normalized risk scores.

In some embodiments, the normalized risk score is calculated for each individual in a cohort of individuals with a given phenotype and a cohort of individuals without a given phenotype.

In some embodiments, a distribution of normalized risk scores for the cohort of individuals with the given phenotype is compared to the cohort of individuals without the given phenotype. In some embodiments, the different genetic backgrounds are different ethnicities.

Some embodiments further comprise providing for at least a subset of phenotypes from the list of prioritized phenotypes a dynamically ranked list of genes or genomic regions associated with each phenotype in the subset of phenotypes, wherein the genes or genomic regions are prioritized based on S_{g}, for each phenotype in the subset of phenotypes.

In some embodiments, the risk score is a genomic risk score.

In some embodiments, the one or more phenotypes are common diseases. In some embodiments, the one or more phenotypes are rare diseases.

In some embodiments, determining the phenotype association score further comprises including an interaction term, wherein a presence of one or more genome sequence variants in a first gene or genomic region in conjunction with a presence of one or more genome sequence variants in a second gene or genomic region provides a risk score that is different from the sum of the risk scores of genome sequence variants in the first gene or genomic region and the second gene or genomic region alone. In some embodiments, the interaction between the presence of one or more genome sequence variants in a first gene or genomic region with the presence of one or more genome sequence variants in the second gene or genomic region causes the subject to have an increased risk score for each of the one or more phenotypes. In some embodiments, the interaction between the presence of one or more genome sequence variants in a first gene or genomic region with the presence of one or more genome sequence variants in the second gene or genomic region causes the subject to have an decreased risk score for each of the one or more phenotypes.

In some embodiments, the outputting comprises providing a report comprising the risk score for each of the one or more phenotypes. In some embodiments, the report is an electronic report. In some embodiments, the report is provided on a user interface with graphical elements that correspond to the prioritized phenotypes. Some embodiments further comprise transmitting the electronic report to a user over a network. In some embodiments, the report comprises only genes or genomic regions with risk scores greater than zero.

Some embodiments further comprise providing a therapeutic intervention subsequent to outputting the list of prioritized phenotypes. In some embodiments, the therapeutic invention comprises treating or monitoring the subject for at least a subset of the one or more phenotypes. In some embodiments, the one or more phenotypes comprise a disease, and wherein the therapeutic invention comprises treating or monitoring the subject for the disease. In some embodiments, the disease is a genetic disease. In some embodiments, the risk score is determined for each of the two or more phenotypes.

Another aspect of the present disclosure provides a non-transitory computer readable medium comprising machine executable code that, upon execution by one or more computer processors, implements any of the methods above or elsewhere herein.

Another aspect of the present disclosure provides a computer system comprising one or more computer processors and a non-transitory computer readable medium coupled thereto. The non-transitory computer readable medium comprises machine executable code that, upon execution by the one or more computer processors, implements any of the methods above or elsewhere herein.

Additional aspects and advantages of the present disclosure will become readily apparent to those skilled in this art from the following detailed description, wherein only illustrative embodiments of the present disclosure are shown and described. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings (also “figure” and “FIG.” herein), of which:

FIG. 1 shows a computer control system that is programmed or otherwise configured to implement methods provided herein.

FIG. 2 shows an exemplary genomic load profile showing a subject's risk for respiratory disease and the genes and genomic variants contributing to the risk.

FIG. 3 shows an exemplary genomic load profile showing a subject's risk for cancer and the genes and genomic variants contributing to the risk.

FIG. 4 shows an exemplary genomic load profile showing a subject's risk for cardiovascular disease and the genes and genomic variants contributing to the risk.

FIG. 5 shows a summary of an exemplary subject's genomic disease load, disease burden, number of genes in disease panel, and genes arising above a certain gene load cutoff.

FIG. 6 illustrates a proband's observed genomic disease load for lung disease relative to the distribution for the general population. In the lower Figure the genomic disease load is transformed into a percentile risk with respect to a population frequency. In the example, the proband may be in the top 1% percentile.

FIG. 7 illustrates an exemplary method to determine burden quantification for a Panel of n genes. Panel Burden, or risk score, is the exit value of the recursion shown above. Di and Hi are the posterior probabilities that gene i is in the disease state (pD) or Healthy state (pH); n is the number of genes in the panel, and i is an individual gene.

### DETAILED DESCRIPTION

While various embodiments of the invention have been shown and described herein, it will be obvious to those skilled in the art that such embodiments are provided by way of example only. Numerous variations, changes, and substitutions may occur to those skilled in the art without departing from the invention. It should be understood that various alternatives to the embodiments of the invention described herein may be employed.

The term “subject,” as used herein, generally refers to an animal, such as a mammalian species (e.g., human) or avian (e.g., bird) species, or other organism, such as a plant. A subject can be a vertebrate, a mammal, a mouse, a primate, a simian or a human. Mammals include, but are not limited to, murines, simians, humans, farm animals, sport animals, and pets. A subject can be a healthy individual, an individual that has or is suspected of having a disease or a pre-disposition to the disease, or an individual that is in need of therapy or suspected of needing therapy. A subject can be a patient.

An “individual” can be of any species of interest that comprises genetic information. The individual can be a eukaryote, a prokaryote, or a virus. The individual can be an animal or a plant. The individual can be a human or non-human animal.

The term “sequencing,” as used herein, generally refers to methods and technologies for determining the sequence of nucleotide bases in one or more polynucleotides. The polynucleotides can be, for example, deoxyribonucleic acid (DNA) or ribonucleic acid (RNA), including variants or derivatives thereof (e.g., single stranded DNA). Sequencing can be performed by various systems currently available, such as, with limitation, a sequencing system by Illumina, Pacific Biosciences, Oxford Nanopore, or Life Technologies (Ion Torrent). Such devices may provide a plurality of raw genetic data corresponding to the genetic information of a subject (e.g., human), as generated by the device from a sample provided by the subject. In some situations, systems and methods provided herein may be used with proteomic information.

“Nucleic acid” and “polynucleotide” refer to both RNA and DNA, including cDNA, genomic DNA, synthetic DNA, and DNA or RNA containing nucleic acid analogs. Polynucleotides can have any three-dimensional structure. A nucleic acid can be double-stranded or single-stranded (e.g., a sense strand or an antisense strand). Non-limiting examples of polynucleotides include chromosomes, chromosome fragments, genes, intergenic regions, gene fragments, exons, introns, messenger RNA (mRNA), transfer RNA, ribosomal RNA, siRNA, micro-RNA, ribozymes, cDNA, recombinant polynucleotides, branched polynucleotides, nucleic acid probes and nucleic acid primers. A polynucleotide may contain unconventional or modified nucleotides.

“Nucleotides” are molecules that when joined together form the structural basis of polynucleotides, e.g., ribonucleic acids (RNA) and deoxyribonucleic acids (DNA). A “nucleotide sequence” is the sequence of nucleotides in a given polynucleotide. A nucleotide sequence can also be the complete or partial sequence of an individual's genome and can therefore encompass the sequence of multiple, physically distinct polynucleotides (e.g., chromosomes).

The “genome” of an individual member of a species can comprise that individual's complete set of chromosomes, including both coding and non-coding regions. Particular locations within the genome of a species are referred to as “loci,” “sites” or “features”. “Alleles” are varying forms of the genomic DNA located at a given site. In the case of a site where there are two distinct alleles in a species, referred to as “A” and “B,” each individual member of a diploid species can have one of four possible combinations: AA; AB; BA; and BB. The first allele of each pair is inherited from one parent, and the second from the other.

A phenotype is any observable trait in an individual. Phenotypes can be produced by a combination of the individual's genotype, environment, and stochastic events. In some cases, phenotype can be a trait such as eye color, hair color, skin color, weight, height, dimples, freckles, lactose intolerance, earwax type, pain sensitivity, memory, or hair loss. In some cases, a phenotype can be a disease, such as psoriasis, prostate cancer, primary biliary cirrhosis, scleroderma, glaucoma, Lou Gehrig's Disease, scoliosis, schizophrenia, hypertriglyceridemia, diabetes, macular degeneration, melanoma, Crohn's disease, irritable bowel syndrome, Parkinson's disease, Alzheimer's disease, or cardiac disease. Other non-limiting examples of diseases include: cardiovascular diseases, autoimmune disorders, viral infection, lipid metabolism disorders, obesity, asthma, Down syndrome, renal function disorders, fluid homeostasis, developmental abnormalities, polycythemia vera, atopic eczema, myotonic dystrophy, neurodegeneration, genetic disease, and Tourette's syndrome. Diseases can be cancers, non-limiting examples of which include: multiple myeloma, lymphoma, Burkitt lymphoma, pediatric Burkitt lymphoma, adult Burkitt lymphoma, B cell lymphoma, solid cancer, hematopoietic malignancies, colon cancer, breast cancer, cervical cancer, ovarian cancer, mantle cell lymphoma, pituitary adenomas, leukemia, prostate cancer, stomach cancer, pancreatic cancer, thyroid cancers, lung cancer, papillary thyroid cancer, bladder cancer, germ cell tumors, brain tumor, and testicular germ cell tumors. A disease can be a common disease.

A common disease can occur in greater than 0.5%, greater than 1%, greater than 2%, greater than 3%, greater than 4%, greater than 5%, greater than 10%, greater than 15%, greater than 20%, greater than 30% or greater than 40% of a given population. A rare disease can occur in less than 1%, less than 0.9%, less than 0.8%, less than 0.7%, less than 0.6%, less than 0.5%, less than 0.4%, less than 0.3%, less than 0.2%, less than 0.1%, or less than 0.05% of a given population. Because prevalence of a given phenotype or disease can vary dramatically between different populations, a given population can be any medically or legally relevant population. Non-limiting examples of relevant populations can be the entire population of a country or region (e.g., the United States, Japan, China, Europe, Asia, Africa, and South America); a gender; an ethnic or racial background (e.g., European ancestry, Asian ancestry, Ashkenazi Jewish, Finnish ancestry, and African ancestry), or any combination thereof.

In some cases, a phenotype is a cellular trait, such as the structure of a subcellular component such as an endosome, nucleus, lysosome, Golgi apparatus, or endoplasmic reticulum. In some cases, a phenotype can be a cellular trait, such as the expression of a specific marker, mRNA or protein. A disease or disease-state can be a phenotype and can therefore be associated with the collection of atoms, molecules, macromolecules, cells, tissues, organs, structures, fluids, metabolic, respiratory, pulmonary, neurological, reproductive or other physiological function, reflexes, behaviors and other physical characteristics observable in the individual through various approaches.

In many cases, a given phenotype can be associated with a specific genotype or genetic profile. For example, an individual with a certain pair of alleles for the gene that encodes for a particular lipoprotein associated with lipid transport may exhibit a phenotype characterized by a susceptibility to a hyperlipidemous disorder that leads to heart disease. In some cases, the genotype associated with the phenotype is a “variant.”

The “genotype” of an individual at a specific site in the individual's genome refers to the specific combination of alleles that the individual has inherited. A “genetic profile” for an individual includes information about the individual's genotype at a collection of sites in the individual's genome. As such, a genetic profile is comprised of a set of data points, where each data point is the genotype of the individual at a particular site.

Genotype combinations with identical alleles (e.g., AA and BB) at a given site are referred to as “homozygous;” genotype combinations with different alleles (e.g., AB and BA) at that site are referred to as “heterozygous.” It should be noted that in determining the allele in a genome using standard techniques AB and BA cannot be differentiated, meaning it may be impossible to determine from which parent a certain allele has been inherited, given solely the genomic information of the individual tested. Moreover, variant AB parents can pass either variant A or variant B to their children. While such parents may not have a predisposition to develop a disease, their children may. For example, two variant AB parents can have children who are variant AA, variant AB, or variant BB. One of the two homozygous combinations in this set of three variant combinations may be associated with a disease. Having advance knowledge of this possibility can allow potential parents to make the best possible decisions about their children's health.

An individual's genotype can include haplotype information. A “haplotype” is a combination of alleles that are inherited or transmitted together. “Phased genotypes” or “phased datasets” provide sequence information along a given chromosome and can be used to provide haplotype information.

A “variant” can be any change in an individual nucleotide sequence compared to a reference sequence. The reference sequence can be a single sequence, a cohort of reference sequences, or a consensus sequence derived from a cohort of reference sequences. An individual variant can be a coding variant or a non-coding variant. A variant wherein a single nucleotide within the individual sequence is changed in comparison to the reference sequence can be referred to as a single nucleotide polymorphism (SNP) or a single nucleotide variant (SNV) and these terms are used interchangeably herein. SNPs that occur in the protein coding regions of genes that give rise to the expression of variant or defective proteins are potentially the cause of a genetic-based disease. Even SNPs that occur in non-coding regions can result in altered mRNA and/or protein expression. Examples are SNPs that defective splicing at exon/intron junctions. Exons are the regions in genes that contain three-nucleotide codons that are ultimately translated into the amino acids that form proteins. Introns are regions in genes that can be transcribed into pre-messenger RNA but do not code for amino acids. In the process by which genomic DNA is transcribed into messenger RNA, introns are often spliced out of pre-messenger RNA transcripts to yield messenger RNA. An SNP can be in a coding region or a non-coding region. An SNP in a coding region can be a silent mutation, otherwise known as a synonymous mutation, wherein an encoded amino acid is not changed due to the variant. An SNP in a coding region can be a missense mutation, wherein an encoded amino acid is changed due to the variant. An SNP in a coding region can also be a nonsense mutation, wherein the variant introduces a premature stop codon. A variant can include an insertion or deletion (INDEL) of one or more nucleotides. An INDEL can be a frame-shift mutation, which can significantly alter a gene product. An INDEL can be a splice-site mutation. A variant can be a large-scale mutation in a chromosome structure; for example, a copy-number variant (CNV) caused by an amplification or duplication of one or more genes or chromosome regions or a deletion of one or more genes or chromosomal regions; or a translocation causing the interchange of genetic parts from non-homologous chromosomes, an interstitial deletion, or an inversion.

A “disease gene model” can refer to the mode of inheritance for a phenotype. A single gene disorder can be autosomal dominant, autosomal recessive, X-linked dominant, X-linked recessive, Y-linked, or mitochondrial. Diseases can also be multifactorial and/or polygenic or complex, involving more than one variant or damaged gene.

“Pedigree” can refer to lineage or genealogical descent of an individual. Pedigree information can include polynucleotide sequence data from a known relative of an individual such as a child, a sibling, a parent, an aunt or uncle, a grandparent, etc.

The term “alignment,” as used herein, generally refers to the arrangement of sequence reads to reconstruct a longer region of the genome. Reads can be used to reconstruct chromosomal regions, whole chromosomes, or the whole genome.

Disclosed herein is an analytical method to predict or determine a subject's phenotype burden and/or genomic load from the subject's genome sequence variants and report a dynamically ordered list of genes or genomic regions responsible for each phenotype. Also disclosed herein is an analytical method to convert the phenotype burden and/or genomic load into a probability or risk profile or percentile for a certain phenotype when compared to a reference population.

### Genomic Sequence Variants

The present disclosure provides methods and systems for detecting genome sequence variants. Genome sequence variants can be detected by assaying a biological sample. A biological sample may comprise a sample from a subject, such as whole blood; blood products; red blood cells; white blood cells; buffy coat; swabs; urine; sputum; saliva; semen; lymphatic fluid; amniotic fluid; cerebrospinal fluid; peritoneal effusions; pleural effusions; biopsy samples; fluid from cysts; synovial fluid; vitreous humor; aqueous humor; bursa fluid; eye washes; eye aspirates; plasma; serum; pulmonary lavage; lung aspirates; animal, including human, tissues, including but not limited to, liver, spleen, kidney, lung, intestine, brain, heart, muscle, pancreas, cell cultures, as well as lysates, extracts, or materials and fractions obtained from the samples described above or any cells and microorganisms and viruses that may be present on or in a sample. A sample may comprise cells of a primary culture or a cell line. Tissues, cells, and their progeny of a biological entity obtained in vivo or cultured in vitro are also encompassed.

There are various approaches for obtaining genome sequence variants from one or more genes or genomic regions from the biological sample from a subject. An exemplary, non-limiting method of determining genome sequence variants is a genotyping array. A genotyping array can be a DNA microarray used to detect polymorphisms. “Genotyping array” refers broadly to any ordered array of nucleic acids, oligonucleotides, proteins, small molecules, large molecules, and/or combinations thereof on a substrate that enables genotypic profiling of a biological sample. Genotyping arrays can contain immobilized, allele-specific oligos. Non-limiting examples of microarrays are available from Affymetrix, Inc.; Agilent Technologies, Inc.; Illumina, Inc.; GE Healthcare, Inc.; Applied Biosystems, Inc.; Beckman Coulter, Inc.; etc.

Genome sequence variants can be identified by sequencing nucleic acids from biological samples. Such sequencing techniques can be high-throughput sequencing techniques. Exemplary non-limiting sequencing techniques can include, for example, emulsion PCR (pyrosequencing from Roche 454, semiconductor sequencing from Ion Torrent, SOLiD sequencing by ligation from Life Technologies, sequencing by synthesis from Intelligent Biosystems), bridge amplification on the flow cell (e.g. Solexa/lllumina), isothermal amplification by Wildfire technology (Life Technologies) or rolonies/nanoballs generated by rolling circle amplification (Complete Genomics, Intelligent Biosystems, Polonator). Sequencing technologies like Heliscope (Helicos), SMRT technology (Pacific Biosciences) or nanopore sequencing (Oxford Nanopore) that allow direct sequencing of single molecules without prior clonal amplification may be suitable sequencing platforms.

Sequencing can be high-throughput sequencing. Sequencing can be high-throughput sequencing and the DNA sample can be extracted genomic DNA. In some cases, the extracted genomic DNA or the sequencing library produced from the extracted DNA is enriched for regions of the genome. In some cases, the enrichment is for exon sequences. In some cases, the enrichment is for genes or genomic regions associated with phenotypes. Enrichment can be performed by hybridization to a sequence specific array. Enrichment can be performed by in-solution hybridization to functionalized probes, followed by pull-down. A non-limiting example of in-solution hybridization enrichment is a set of probes to cancer-related genes with attached biotin moieties. For example, the genomic DNA or sequencing libraries can be melted; the single-stranded DNA can be hybridized to the probes; the probe:target hybrids can be pulled down with streptavidin-coated magnetic beads; the remaining solution containing the unbound DNA can be removed; the beads with the probe-target hybrids can be washed; the enriched DNA can be eluted from the bead and sequenced. Enrichment can be performed by PCR. In some cases, genomic-region or gene-specific oligos are used to amplify specific targets. In some cases, the oligos comprise adaptors. In some cases, the adaptors comprise sequencing adaptors. In some cases, the adaptors comprise common PCR priming sites.

Variants can be determined by comparison of reads to a reference. The reference can be the human genome. The comparison can be performed by a sequence alignment algorithm. A sequence alignment algorithm can be Burrows-Wheeler Aligner (BWA), the Genome Analysis Toolkit (GATK; Broad Institute), Bowtie, or BLAST. Genome sequence variants can be provided in a variant file, for example, a genome variant file (GVF) or a variant call format (VCF) file. Sequence alignments can be stored as Sequence Alignment/Map (SAM) files, Binary Alignment/Map (BAM) files, or any other appropriate file structure that indicates a position and/or alignment of a mapped sequence. According to the methods disclosed herein, tools can be provided to convert a variant file provided in one format to another more preferred format. A variant file can comprise frequency information on the included variants.

### Determination of Risk Scores

A risk score can be determined for one or more phenotypes. A risk score may be used to prioritize, evaluate, aggregate, sort, group, or analyze one or more phenotypes. A risk score can relate to a single phenotype or a plurality of phenotypes. A risk score may be used prioritize two or more phenotypes. A risk score may be determined for one or more particular phenotypes. As a non-limiting example, a risk score may be determined for a particular phenotype, such as obesity, or disease area, such as for a cancer or a genetic disease.

A risk score can be a genomic risk score. A risk score can be indicative of a genetic predisposition for a disease in a subject. A risk score can be indicative of a disease derived from germ-line or somatic mutations, including but not limited genetic diseases and cancer, or a combination thereof. A risk score can relate to pharmacogenomic risk. A risk score may be a composite score.

A risk score can be determined in any of several ways. A risk score can be determined by summing, aggregating, multiplying, dividing, iterating, or any combination thereof. A risk score can be determined using one or more recursive functions. A risk score can be a posterior probability or conditional probability.

A risk score can be determined in part by combining phenotype association scores for the genomic sequence variants present in the biological sample. Phenotype association scores can be combined using any of several techniques not limited to summing, aggregating, multiplying, dividing, iterating, or any combination thereof. Phenotype association scores can be combined using a recursive function. A recursive function can be used to determine a conditional probability or posterior probability. A risk score can be determined using a conditional probability or a posterior probability.

Phenotype association scores can be based in part on the likelihood that the subject will present a phenotype given a genotype. Phenotype association scores can be calculated partly based a variant priority score from a variant prioritization tool. Phenotype association and/or variant prioritization scores can be based partly on the frequency of a genotype in a population that has the phenotype compared to a population that lacks the phenotype. Phenotype association scores and/or variant prioritization scores can be based partly on features of the sequence that the genome sequence variant occurs in.

For example, sequence variants that disrupt the functioning of the CTFR gene may result in an increased risk of cystic fibrosis. If a genomic variant with unknown significance is detected within the CTFR gene, the sequence characteristics of the CTFR gene can partly be used to determine the phenotype association score. In one example, the mutation does not change the predicted amino acid sequence of the protein of the protein, and the mutation has a weak (or even no) phenotype association score. In a second example, a mutation inserts a premature stop codon, and the genome sequence variant has a strong phenotype association score. In another example, the genome sequence variant is located within an intron and not near a splice junction, and it has a weak phenotype association score. Exemplary, non-limiting sequence characteristics can be gene structure, exon structure, intron structure, gene splice junctions, promoter regions, noncoding ribonucleic acid sequence, amino acid coding sequence, promoter regions, and untranslated regions.

There are various approaches for producing variant prioritization scores to determine a strength of association between a genotype and a phenotype. Non-limiting examples of variant prioritization tools can be the Variant Annotation, Analysis and Search Tool (VAAST); pedigree-Variant Annotation, Analysis, and Search Tool (pVAAST); Sorting Intolerant from Tolerant (SIFT); Annotate Variation (ANNOVAR); burden-tests; and sequence conservation tools. Exemplary embodiments of variant prioritization tools are described in U.S. Patent Publication No. 2013/0332081 and PCT Application No. PCT/US2015/029318, which are hereby incorporated by reference in their entirety.

Variant prioritization tools may comprise a variety of gene burden tests. As a non-limiting example of a genetic burden test, VAAST can employ a variant association test that combines amino acid substitution severity, sequence conservation, and allele frequency information for a gene or genomic region using a composite likelihood ratio test (CLRT). In another example, pVAAST is based on VAAST and incorporates family data. pVAAST performs linkage analysis by calculating a gene-based LOD score using a model specifically designed for sequence data with support for dominant, recessive, and de novo inheritance. In yet another example, SIFT predicts whether an amino acid substitution affects protein function. SIFT prediction is based on the degree of conservation of amino acid residues in sequence alignments derived from closely related sequences, collected through PSI-BLAST. In a further example, ANNOVAR prioritizes SNVs by (i) performing gene-based annotation to identify exonic/splicing variants; (ii) removing synonymous or non-frameshift variants; (iii) identify variants within regions conserved amongst different species; remove variants in segmental duplication regions; optionally, remove variants in 1000 Genomes Project and dbSNP; remove “dispensable” genes with high-frequency loss-of-function variants in healthy populations.

A phenotype or variant prioritization score can be based at least in part on a knowledge resident in one or more biomedical ontologies. Non-limiting examples of tools that can associate genes with biomedical ontologies are Phenomizer, Symptom- and Sign-Assisted Genome Analysis (sSaga), and Phenotype Driven Variant Ontological Re-ranking tool (Phevor). Phenomizer determines a likelihood that a subject has a genetic disorder based on entered phenotype terms and knowledge resident in the Human Phenotype Ontology. sSaga matches clinical terms from symptom categories to established, recessive genetic diseases to prioritize genome variants.

Phevor can improve diagnostic accuracy using patient phenotype and candidate-gene information derived from multiple sources. A user can input a subject's phenotypes using terms from one or more biomedical ontologies. Non-limiting examples of ontologies include the Human Phenotype Ontology (HPO), the Gene Ontology (GO), the Mammalian Phenotype Ontology (MPO), or OMIM disease terms. Phevor employs information in each of the one or more ontologies to propagate information amongst the ontologies. Phevor first identifies all the genes associated with a set of ontological terms from a database (e.g., HPO). If no genes are associated with an ontological term, then Phevor traverses the ontology towards its root until Phevor reaches the first node associated with genes. After obtaining an associative list of genes and nodes, other ontologies are searched using the identified genes to determine a list of ontological terms associated with the gene list. The resulting list of identified and associated nodes are the starting or seed nodes.

Once a set of starting nodes for each ontology has been identified, e.g. those provided by the user in their phenotype list, or derived from the phenotype list by the cross-ontology linking procedure described in the preceding paragraph, Phevor propagates this information across each ontology using, for example, ontological propagation. Each seed node is assigned a value. The value can be greater than zero (e.g., 0.001, 0.002, 0.003, 0.004, 0.005, 0.006, 0.007, 0.008, 0.009, 0.01, 0.02, 0.03, 0.04, 0.05, 0.06, 0.07, 0.08, 0.09, 0.1, 0.2, 0.3, 0.4, 0.5, 0.6, 0.7, 0.8, 0.9, 1, 2, 3, 4, 5, 6, 7, 8, 9, 10, 20, 30, 40, or more). This information may then be propagated across the ontology as follows. Proceeding from each seed node toward its children, each time an edge is crossed to a neighboring node, the current value of the previous node is divided by a constant (e.g., 2, 3, 4, 5, 6, 7, 8, 9, 10, 20, 30, 40, 50, etc). For example, if the starting seed node has two children, its value can be divided in half for each child, so in this case, both children receive a value of ½. This process is continued until a terminal node is encountered. The original seed scores are also propagated upwards to the root node(s) of the ontology using the same procedure. Different values for starting nodes and different divisors can be chosen than those indicated. The constant used to divide the value of the preceding node during propagation can be different for each ontology. The constant used to divide the value of the preceding node during propagation can be a measure of the strength of the relationship between ontological terms in a biomedical ontology. For example, consider a biomedical ontology in which ontological terms are based on shared membership in a biochemical pathway. It is highly likely that a mutation in one gene in the pathway will cause a similar phenotype to that of a mutation in a second gene in the same pathway. In such a case, the constant that is used to divide the preceding nodes value by can be very small. Consider a second example, where ontological terms are based on coexpression of two gene products. It is highly likely that two genes can be expressed in the same cell and not contribute to the same phenotype. In such a case, the constant that is used to divide the preceding nodes value by can be relatively large. The value used to divide the value of the preceding node during propagation can be a variable. The variable can be related to the strength of the evidence of the relationship between the seed node and its child node. The variable can be related to the number of child nodes attached to the seed node.

In practice there can be many seed nodes. In such cases intersecting threads of propagation are first combined by adding them, and the process of propagation proceeds as previously described. One interesting consequence of this process is that nodes far from the original seeds can attain high values, greater even than any of the starting seed nodes.

Upon completion of propagation, each node's value can be renormalized to a value between zero and one by dividing it by the sum of all nodes in the ontology. Phevor can assign each gene annotated to the ontology a score corresponding to the maximum score of any node in the ontology to which it is annotated. This process can be repeated for each ontology, thus genes annotated to more than one ontology can have a score from each. These scores can be added to produce a final sum score for each gene, and renormalized again to a value between one and zero. Consider a set of known disease genes drawn from HPO and assigned gene scores by the process described in the preceding paragraphs. Consider also a similar list of human genes derived from propagation across GO. Summing each gene's HPO and GO scores and renormalizing again by the total sum of sums will combine these lists.

During propagation across an ontology, intersecting threads can result in nodes having scores that equal or even exceed those of any original seed nodes. Thus a gene not yet associated with a particular human disease can become an excellent candidate, because it is annotated to an HPO node located at an intersection of phenotypes associated with other diseases, or has GO functions, locations and/or processes similar to those of known disease-genes annotated to HPO. Phevor can also employ the Mammalian Ontology, allowing it to leverage model organism phenotype information, and the Disease Ontology, which provides it with additional information pertaining to human genetic disease.

Upon completion of all ontology propagation, combination, and gene scoring steps described in the preceding paragraphs, genes can be ranked using their gene sum scores; then their percentile ranks can be combined with variant and gene prioritization scores as follows. Phevor can calculate a disease association score for each gene or genomic region,

D_{g}=(1−V_{g})×N_{g} Eq. 1,

where N_{g} is the renormalized gene sum score derived from the ontological combination propagation procedures, and V_{g} is the percentile rank of the gene provided by the external variant prioritization tool, e.g. ANNOVAR, SIFT and PhastCons (except for VAAST, in which case its reported p-values can be used directly). Phevor then can calculate a second score summarizing the weight of evidence that the gene is not involved with the patient's illness, H_{g}, i.e. neither the variants nor the gene are involved in the patient's disease,

H_{g}=V_{g}×(1−N_{g}) Eq. 2.

An example of a phenotype association is a Phevor score (Eq. 3), which is the log₁₀ ratio of disease association score (D_{g}), and the healthy association score (H_{g}),

S_{g}=log₁₀D_{g}/H_{g} Eq. 3.

In order to determine a risk score for a given phenotype, the phenotype association score for each gene or genomic region can be combined. In one embodiment, phenotype association scores can be combined by a summing procedure. In another embodiment, the phenotype association scores are combined using regression models. Non-limiting examples of regression models can be linear, non-linear, mixed effect, generalized mixed effect, generalized estimating equations, and frailty models. Such models can analyze associations with some, any, or all continuous and/or categorical multivariate phenotypes. Combining phenotype association scores can include a correction factor for the number of genes or genomic regions contributing to the combined phenotype association score. Combining phenotype association scores can include a correction factor for the strength of the individual phenotype association score. Combining phenotype association scores can take into account the underlying distribution of genes or genomic regions. For example, it may not be appropriate to simply add the phenotype association scores of adjacent genes or genomic regions as adjacent genes or genomic regions can be in linkage disequilibrium.

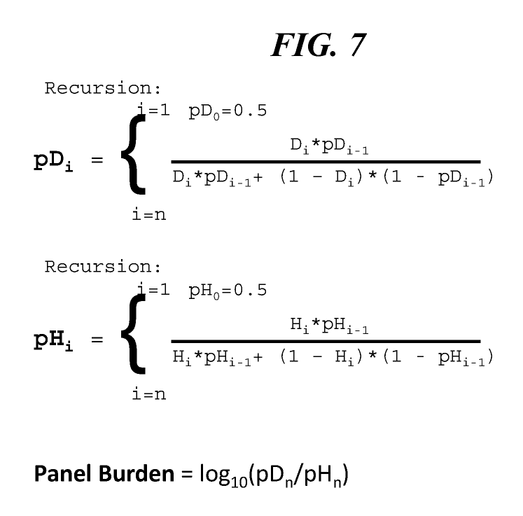

There are additional methods to determine a total phenotype association score based on combined phenotype association scores of individual genes and genomic regions (e.g., a gene panel). In one embodiment, this can be determined using the formulas shown in FIG. 7. This series of calculations is used to obtain a composite score that the gene panel as a whole is in the disease state, (pD), or the healthy state (pH). In some cases, this can be calculated for a panel through the recursive process described in FIG. 7 A gene panel's combined phenotype association score can be the ratio of these two values, e.g. Sₚₐₙₑₗ=log₁₀(pD/pH). This ratio provides an approach to weight and sort genes for priority, strength of association or diagnostic importance. A score S<=0 may be considered to be of lower priority, strength of association or diagnostic importance than those with values of S>1.

Phenotype association scores for each marker can be weighted by the severity of the phenotype. Severity can be an extent to which a phenotype differs from a reference population. Severity can be defined as its impact on quality of life and/or health. Quality of life can be related to mobility, independence of living, disablement, impairment of cognitive function, disruption of routine, and/or frequency of medical intervention. In some cases, metrics of quality of life can be selected by the subject. In some cases, severity of a phenotype is related to severity of a disease. In some cases, severity is related to the level of treatment required for a disease. In some cases, severity is related to the likelihood that the disease is likely to physically manifest within a given time frame, such as 6 months, 1 year, 2 years, 3 years, 4 years, 5 years, 10 years, 20 years, 25 years, or 30 years. In some cases, phenotype association scores can be at least in part based on penetrance of the phenotype given a genotype. Penetrance can be the proportion of individuals carrying a particular variant in a population that also express a particular associated phenotype. In some cases, penetrance can be already accounted for by a variant prioritization tool. Weighting by penetrance can be performed, for example, such that markers, genes, or genomic regions that are highly penetrant can be weighted such that the phenotype association score is higher than low penetrance markers, genes, or genomic regions.

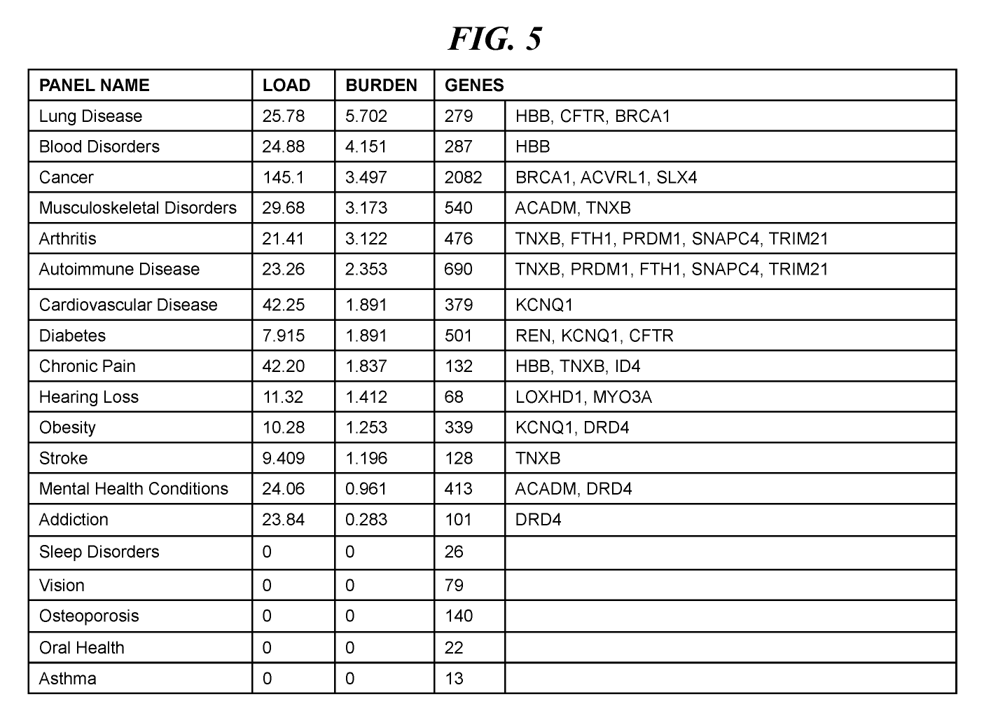

A gene or genomic region's phenotype association scores can be combined if the phenotype association score of the given gene or genomic region are is a given cutoff. The cutoff can be a phenotype association score indicating that the gene or genomic region does not contribute to the phenotype. In some cases the cutoff of the phenotype association score can be zero. In some cases the cutoff for the phenotype association score can be based on the calculated likelihood that a person with the one or more genome sequence variant in the gene or genomic region will exhibit the phenotype. In some cases, the likelihood can be 10% more likely, 20% more likely, 30% more likely, 40% more likely, 50% more likely, 60% more likely, 70% more likely, 80% more likely, 90% more likely, 100% more likely, 120% more likely, 140% more likely, 160% more likely, 180% more likely, 200% more likely, 300% more likely, 400% more likely, or 500% more likely. The cutoff can be based on an expected probability that the phenotype is present in a background population. The cutoff can be based on an expected “average” phenotype association score within the population for a given gene or genomic region. In some cases, a risk score based on combined phenotype association scores without using a cutoff is referred to as a panel load, a genomic load, or a disease load (see FIG. 5). A genomic load can be highly impacted by numerous variants of small impact (see FIG. 5, Cancer).

Methods are also described that make it possible to compare the cumulative genetic burden between and among panels for different phenotypes or diseases, even when they contain no genes in common, and contain different numbers of genes (see FIG. 5). In some embodiments, internal permutation calculation is performed to normalize combined phenotype association scores (Panel Burden scores in FIG. 7). In one example, VAAST p-values for the genes in a panel are randomly replaced with those of another gene, and the resulting D_{g} and H_{g} are re-calculated as shown in FIG. 7. The newly calculated values can then be used to determine a new combined phenotype association score, (e.g. risk score or Panel Burden). The process can repeated some number of times, such as at least 10, at least 50, at least 100, at least 1000, at least 10000 times and the average panel burden across the permutations is calculated to provide an expected Risk Score, or Panel Score, PBₑₓₚ. This value is then subtracted from the actual observed combined phenotype association score, or Panel Burden, PB_{obs} to give a unitless, normalized panel score PBₙₒᵣₘ as shown in Equation 5.

PBₙₒᵣₘ=PB_{obs}−PBₑₓₚ. Eq. 5

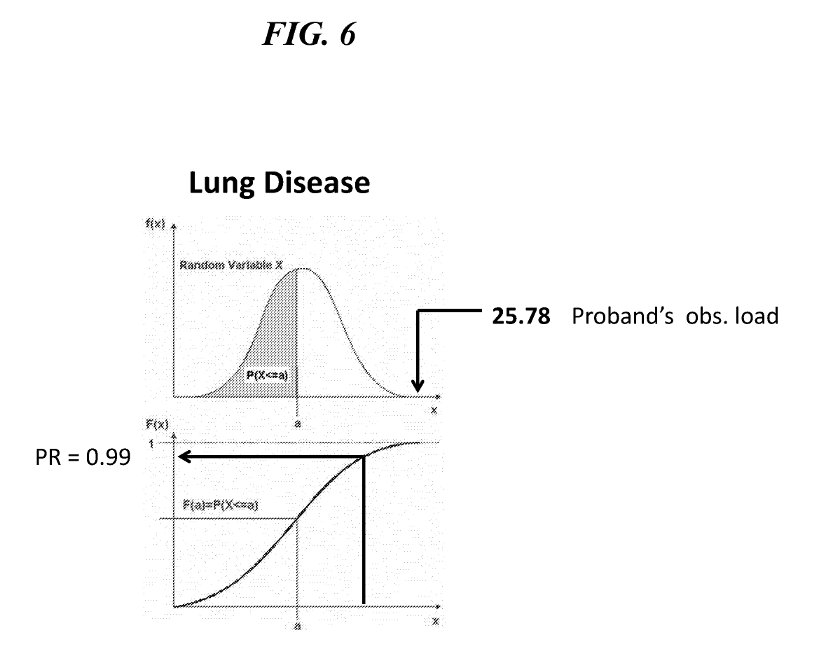

These normalized scores can make it possible to compare individuals belonging to different ethnicities. This is possible because the internal permutations control for population stratification and race effects that can inflate phenotype association scores, such as VAAST p-values, genome wide. Normalized panel burden scores (PBₙₒᵣₘ) also enable a variety of novel bioinformatics actions. For example, they can be used to rank panels relative to one another to identify a disease area wherein a patient has the higher burden (e.g. Cardiovascular disease relative to Cancer). PBₙₒᵣₘ scores for a given panel can also be obtained for a cohort of healthy patients, and the distribution of those PBₙₒᵣₘ scores for a given panel can be used to determine the deviation of a given proband's panel burden compared to the mean or median for the control cohort (see FIG. 6, for illustration). These same calculations can also be extended for case/control studies.

### Generating a Report

An electronic report summarizing a genetic burden and/or load for a set of phenotypes can be generated for a subject. Such a report can rank phenotypes by risk score. The report can summarize the number of genes or genomic regions that have phenotype association scores in different ranges of values. In some cases, the subject has indicated which phenotypes for which he or she wishes to be evaluated, and the report only provides information on those phenotypes. In some cases, the phenotypes are diseases. In some cases, the phenotypes are diseases for which the subject has a family history. In some cases, the phenotypes are neurological diseases. In some cases, the phenotypes are diseases for which therapies, preventative measures, or treatments exist. In some cases the report can be a paper report provided to the individual or healthcare provider.

For each phenotype reported, information can be provided on the number of genes associated with the phenotype. Evidence for each gene's inclusion in the phenotype profile can be summarized and/or reported. A disease model, comprising information on the predicted inheritance mode for each gene or genome sequence variant can be provided. For example, the report can indicate that a gene or genomic region is associated with a phenotype and the genome sequence variant is likely to be dominant to the reference allele. In another example, the report can indicate that a gene or genomic region is associated with a phenotype and the genome sequence variant is likely to be recessive to the reference allele. In yet another example, the report can comprise genes or genomic regions with risk scores greater than zero. In some instances, the report can comprise only genes or genomic regions with risk scores greater than zero.

The genes or genomic regions contributing to the genetic burden or load can be dynamically ranked. Dynamic ranking can indicate that genes are ranked based on their association within a given phenotypic category. For example, BRCA1 can have a higher phenotype association score for cancer than for respiratory disease; CTFR has a higher phenotype association score for respiratory disease than cancer. BRCA1's position relative to CTFR is not necessarily stable, but can vary based on each gene's respective contributions to a given phenotype (e.g., BRCA1 is presented before CTFR for the cancer phenotype, but after CTFR for the respiratory disease phenotype). Dynamically ranking genes using the methods disclosed herein, or combining the methods disclosed herein with Natural Language Processing of Literature methods, or genomic regions containing genome sequence variants within each phenotypic category allows diagnostically important information to be presented at the top of the list and can facilitating medical decision-making.

The genomic load or genetic burden of an individual may also be compared to a reference population for any particular phenotype. The reference population may be changed depending on the ethnicity of the individual, so that the individual is compared to an ethnically matched reference population. For individuals of mixed population, one can determine the ethnic background of regions and/or haplotype blocks of the genome of the individual genome, and then match these regions with the appropriate matching reference population database for that region. Non-limiting examples of reference populations can be a population from a country or region (e.g., the United States, Japan, China, Europe, Asia, Africa, and South America); a gender; an ethnic or racial background (e.g., European ancestry, Asian ancestry, Ashkenazi Jewish, Finnish ancestry, and African ancestry), or any combination thereof. The reference population can be based on shared environmental influences or life events, such as smokers, hormone therapy, disease status, exposure to chemicals or medications, or pregnancy, for example. The reference population can be adjusted by age. That comparison may indicate whether that individual has a higher risk, average risk or lower risk to developing that phenotype relative to that reference population. In some cases, that comparison is made to the mean, median or mode genomic load of the reference population for that phenotype. In some instances, the distribution of the genomic load or burden may be normally distributed and characterized by a standard deviation, coefficient of variation, or other statistical measurement. Then, the genomic load or burden for that individual may be compared to the standard deviation, coefficient of variation or other statistical measurement to create a comparison value of the risk of developing that phenotype when compared to the reference population. This comparison value may be expressed as a percent likelihood risk compared to the reference population of developing the phenotype (see FIG. 6). A list of two or more phenotypes prioritized using systems and methods disclosed herein can be used to provide a therapeutic intervention for a subject. A therapeutic intervention can be an intervention that produces a therapeutic effect, (e.g., is therapeutically effective). Therapeutically effective interventions can prevent, slow the progression of, improve the condition of (e.g., causes remission of), or cure a disease, such as a cancer. A therapeutic intervention can include, for example, administration of a treatment, such as chemotherapy, radiation therapy, surgery, immunotherapy, administration of a pharmaceutical or a nutraceutical, or, a change in behavior, such as diet. A therapeutic intervention can include detection of a phenotype or monitoring a subject for a phenotype. A therapeutic intervention can include delivering information regarding prioritized phenotypes in a report.

The therapeutic intervention can be provided at various points in time. In some instances, a therapeutic intervention can be provided subsequent to outputting the list of prioritized phenotypes. The therapeutic intervention can be provided concurrently with or prior to outputting the list of prioritized phenotypes.

### Computer Systems

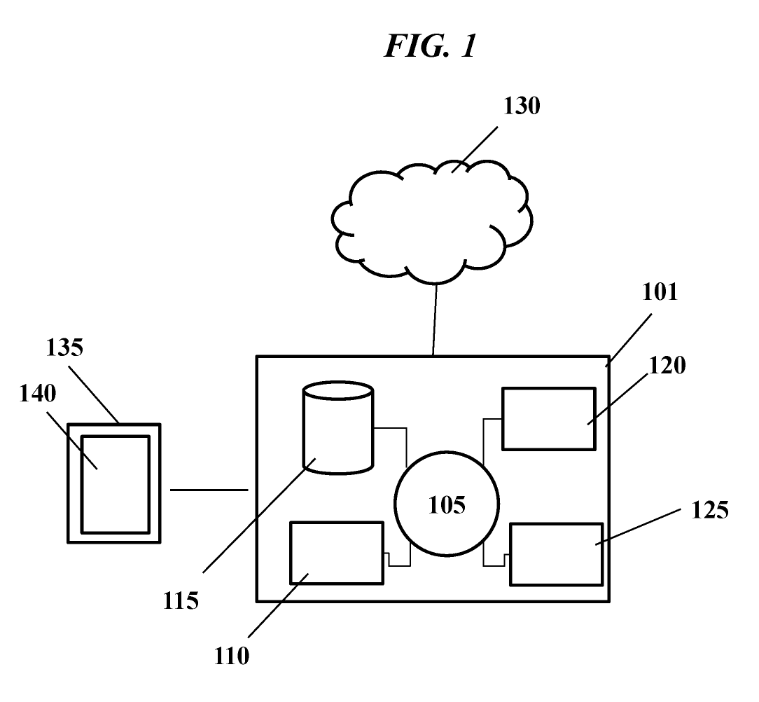

The present disclosure provides computer control systems that are programmed to implement methods of the disclosure. FIG. 1 shows a computer system 101 that is programmed or otherwise configured to implements methods of the present disclosure. The computer system 101 can be integral to implementing methods provided herein, which may be otherwise extremely difficult to perform in the absence of the computer system 101. The computer system 101 can regulate various aspects of methods of the present disclosure, such as, for example, methods that integrate phenotype and disease information with personal genomic data report a prioritized list of phenotypes and potential phenotype-causing variants to a subject. The computer system 101 can be an electronic device of a user or a computer system that is remotely located with respect to the electronic device. The electronic device can be a mobile electronic device. As an alternative, the computer system 101 can be a computer server.

The computer system 101 includes a central processing unit (CPU, also “processor” and “computer processor” herein) 105, which can be a single core or multi core processor, or a plurality of processors for parallel processing. The computer system 101 also includes memory or memory location 110 (e.g., random-access memory, read-only memory, flash memory), electronic storage unit 115 (e.g., hard disk), communication interface 120 (e.g., network adapter) for communicating with one or more other systems, and peripheral devices 125, such as cache, other memory, data storage and/or electronic display adapters. The memory 110, storage unit 115, interface 120 and peripheral devices 125 are in communication with the CPU 105 through a communication bus (solid lines), such as a motherboard. The storage unit 115 can be a data storage unit (or data repository) for storing data. The computer system 101 can be operatively coupled to a computer network (“network”) 130 with the aid of the communication interface 120. The network 130 can be the Internet, an internet and/or extranet, or an intranet and/or extranet that is in communication with the Internet. The network 130 in some cases is a telecommunication and/or data network. The network 130 can include one or more computer servers, which can enable distributed computing, such as cloud computing. The network 130, in some cases with the aid of the computer system 101, can implement a peer-to-peer network, which may enable devices coupled to the computer system 101 to behave as a client or a server.

The CPU 105 can execute a sequence of machine-readable instructions, which can be embodied in a program or software. The instructions may be stored in a memory location, such as the memory 110. The instructions can be directed to the CPU 105, which can subsequently program or otherwise configure the CPU 105 to implement methods of the present disclosure. Examples of operations performed by the CPU 105 can include fetch, decode, execute, and writeback.

The CPU 105 can be part of a circuit, such as an integrated circuit. One or more other components of the system 101 can be included in the circuit. In some cases, the circuit is an application specific integrated circuit (ASIC).

The storage unit 115 can store files, such as drivers, libraries and saved programs. The storage unit 115 can store user data, e.g., user preferences and user programs. The computer system 101 in some cases can include one or more additional data storage units that are external to the computer system 101, such as located on a remote server that is in communication with the computer system 101 through an intranet or the Internet.

The computer system 101 can communicate with one or more remote computer systems through the network 130. For instance, the computer system 101 can communicate with a remote computer system of a user (e.g., patient, healthcare provider, or service provider). Examples of remote computer systems include personal computers (e.g., portable PC), slate or tablet PC's (e.g., Apple® iPad, Samsung® Galaxy Tab), telephones, Smart phones (e.g., Apple® iPhone, Android-enabled device, Blackberry®), or personal digital assistants. The user can access the computer system 101 via the network 130.

Methods as described herein can be implemented by way of machine (e.g., computer processor) executable code stored on an electronic storage location of the computer system 101, such as, for example, on the memory 110 or electronic storage unit 115. The memory 110 can be part of a database. The machine executable or machine readable code can be provided in the form of software. During use, the code can be executed by the processor 105. In some cases, the code can be retrieved from the storage unit 115 and stored on the memory 110 for ready access by the processor 105. In some situations, the electronic storage unit 115 can be precluded, and machine-executable instructions are stored on memory 110.

The code can be pre-compiled and configured for use with a machine having a processor adapted to execute the code, or can be compiled during runtime. The code can be supplied in a programming language that can be selected to enable the code to execute in a pre-compiled or as-compiled fashion.

Aspects of the systems and methods provided herein, such as the computer system 101, can be embodied in programming. Various aspects of the technology may be thought of as “products” or “articles of manufacture” typically in the form of machine (or processor) executable code and/or associated data that is carried on or embodied in a type of machine readable medium. Machine-executable code can be stored on an electronic storage unit, such as memory (e.g., read-only memory, random-access memory, flash memory) or a hard disk. “Storage” type media can include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer into the computer platform of an application server. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to non-transitory, tangible “storage” media, terms such as computer or machine “readable medium” refer to any medium that participates in providing instructions to a processor for execution.

Hence, a machine readable medium, such as computer-executable code, may take many forms, including but not limited to, a tangible storage medium, a carrier wave medium or physical transmission medium. Non-volatile storage media include, for example, optical or magnetic disks, such as any of the storage devices in any computer(s) or the like, such as may be used to implement the databases, etc. shown in the drawings. Volatile storage media include dynamic memory, such as main memory of such a computer platform. Tangible transmission media include coaxial cables; copper wire and fiber optics, including the wires that comprise a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a ROM, a PROM and EPROM, a FLASH-EPROM, any other memory chip or cartridge, a carrier wave transporting data or instructions, cables or links transporting such a carrier wave, or any other medium from which a computer may read programming code and/or data. Many of these forms of computer readable media may be involved in carrying one or more sequences of one or more instructions to a processor for execution.

The computer system 101 can include or be in communication with an electronic display 135 that comprises a user interface (UI) 140 for providing, for example, genetic information, such as an identification of disease-causing alleles in single individuals or groups of individuals. Examples of UI's include, without limitation, a graphical user interface (GUI) and web-based user interface (or web interface).

Methods and systems of the present disclosure can be implemented by way of one or more algorithms. An algorithm can be implemented by way of software upon execution by the central processing unit 1105. The algorithm can, for example, prioritize a set of two or more phenotypes based on a risk score of each of the two or more phenotypes.

### EXAMPLES

### Example 1: Prioritizing Phenotypes and Dynamically Ranking Genes

Whole-genome sequencing data is procured from a proband. The sequencing data is used to produce a .vcf file summarizing the proband's genome sequence variants. The .vcf file is modified to include a single copy of a dominant KCNQ1 allele causing early onset Atrial Fibrillation; a compound heterozygous genotype for CFTR (i.e., one Δ509 allele and one missense allele); a coding allele in HBB; a non-coding allele for HBB; and a haploinsufficient allele of BRCA1 with a splice site removed. Based on these mutations, it is expected that the proband be identified as having an increased risk of lung disease, cancer, and cardiovascular disease.

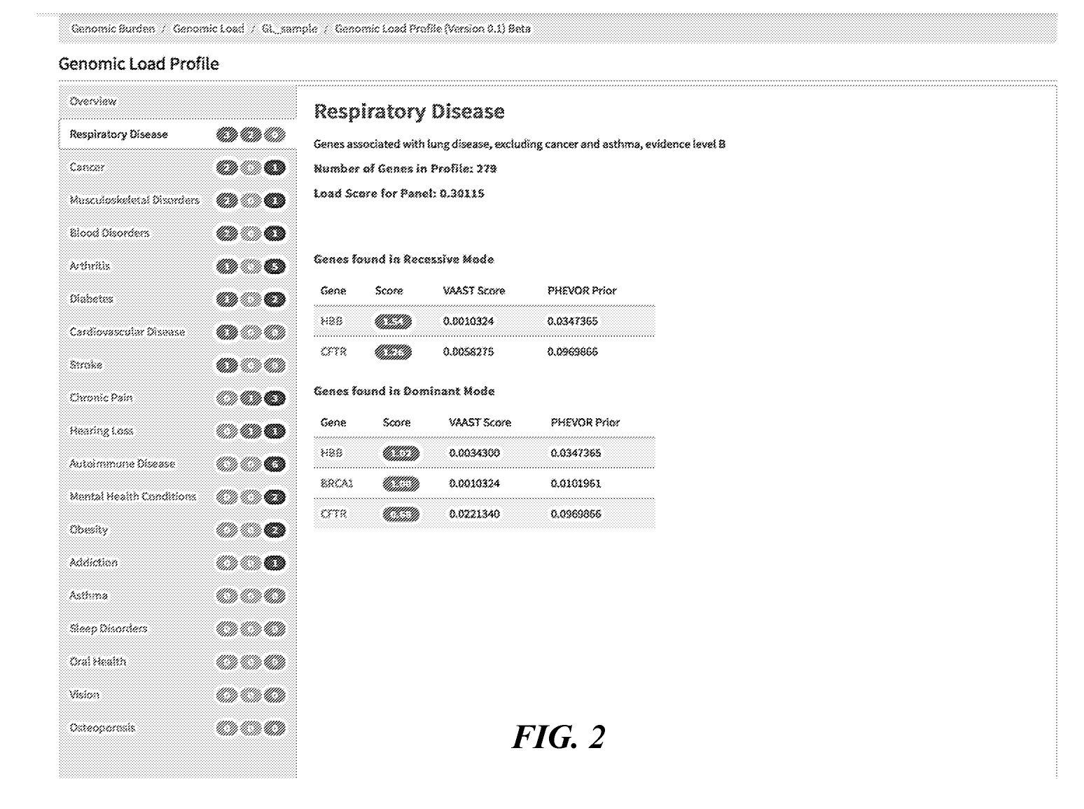

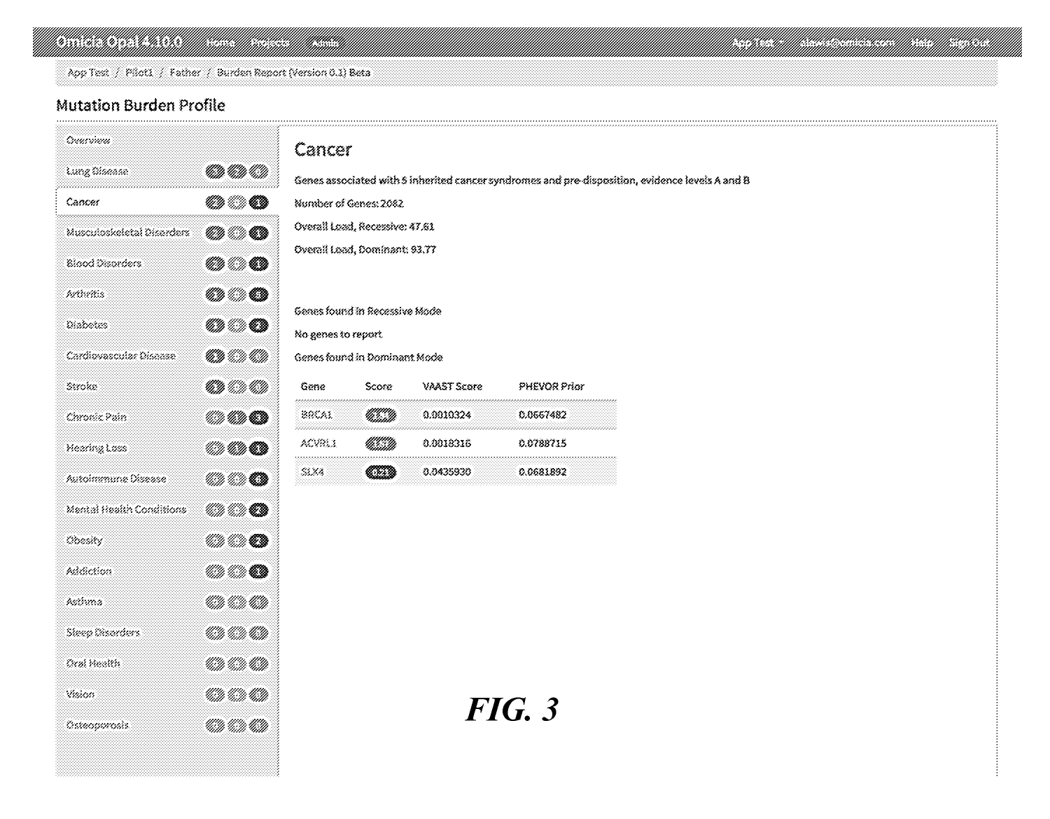

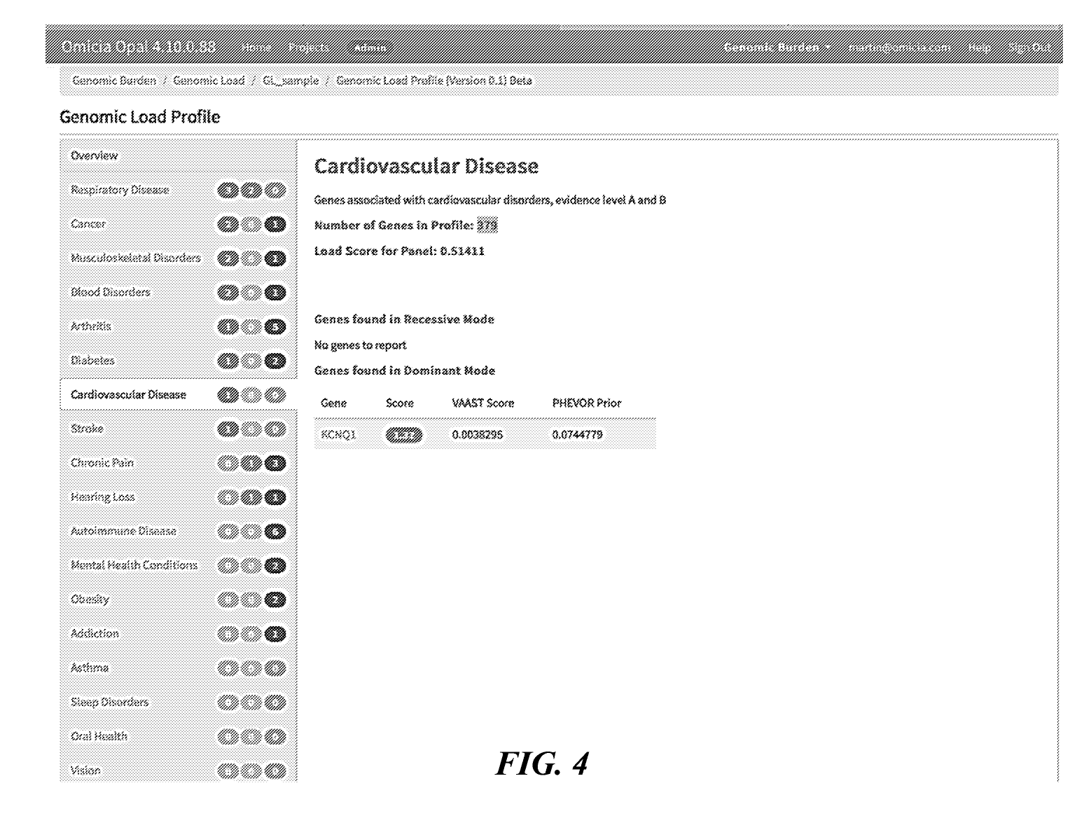

The proband's .vcf file is analyzed using VAAST to generate a variant prioritization score, and by PHEVOR to produce a phenotype association score (indicated as “score” in FIGS. 2-4). A risk score is determined (referred to as Burden in FIG. 5) by combining the phenotype association scores. The phenotypes are ranked by risk score, indicating that the proband is most at risk for developing respiratory disease and cancer (FIGS. 2-4). Within the report on the respiratory disease phenotype, the contributing genes are ranked by their phenotype association scores. For respiratory disease, HBB and CFTR contribute the most to the phenotype, above BRCA1 (FIG. 2). Within the cancer category BRCA1 contributes most highly; the proband is also identified as having an ACVRL1 genotype that may increase his or her risk for cancer (FIG. 3).

Methods and systems of the present disclosure may be combined with or modified by other methods and systems, such as, for example, those described in U.S. Patent Publication No. 2012/0143512, 2013/0332081 and 2016/0092631, and PCT/US2015/029318, each of which is entirely incorporated herein by reference.

While preferred embodiments of the present invention have been shown and described herein, it will be obvious to those skilled in the art that such embodiments are provided by way of example only. It is not intended that the invention be limited by the specific examples provided within the specification. While the invention has been described with reference to the aforementioned specification, the descriptions and illustrations of the embodiments herein are not meant to be construed in a limiting sense. Numerous variations, changes, and substitutions will now occur to those skilled in the art without departing from the invention. Furthermore, it shall be understood that all aspects of the invention are not limited to the specific depictions, configurations or relative proportions set forth herein which depend upon a variety of conditions and variables. It should be understood that various alternatives to the embodiments of the invention described herein may be employed in practicing the invention. It is therefore contemplated that the invention shall also cover any such alternatives, modifications, variations or equivalents. It is intended that the following claims define the scope of the invention and that methods and structures within the scope of these claims and their equivalents be covered thereby.

1.-124. (canceled)

125. A method of prioritizing two or more phenotypes based on a risk score of each of said two or more phenotypes, comprising:
(a) obtaining one or more genome sequence variants from one or more genes or genomic regions of a biological sample of a subject;
(b) determining, using a programmed computer processor, a risk score for each of said two or more phenotypes by:
(i) determining a phenotype association score for each gene or genomic region in said one or more genes or genomic regions to provide a plurality of phenotype association scores;
(ii) combining said plurality of phenotype association scores to provide said risk score for each of said two or more phenotypes;
(c) prioritizing said two or more phenotypes based on said risk score for each of said two or more phenotypes, thereby providing a list of prioritized phenotypes; and
(d) outputting said list of prioritized phenotypes.

126. The method of claim 125, further comprising (e) providing for at least a subset of phenotypes from said list of prioritized phenotypes a dynamically ranked list of genes or genomic regions associated with each phenotype in said subset of phenotypes.

127. The method of claim 126, wherein said dynamically ranked list is ordered based on said phenotype association score.

128. The method of claim 125, wherein said two or more genome sequence variants are determined by high-throughput sequencing.

129. The method of claim 128, wherein said obtaining comprises mapping sequencing reads from said high-throughput sequencing to a reference genome.

130. The method of claim 125, wherein said two or more phenotypes comprise a disease, a term from phenotype ontologies, a term from disease ontologies, or any combination thereof.

131. The method of claim 125, wherein said phenotype association score is based at least in part on a prioritization score from a variant prioritization tool.

132. The method of claim 131, wherein said prioritization score is based on sequence characterization of said given gene or genomic region.

133. The method of claim 132, wherein said sequence characterization comprises one or more characterizations selected from the group consisting of gene, exon, intron, splice site, amino acid coding sequences, promoters, noncoding RNAs, and untranslated regions.

134. The method of claim 131, wherein said phenotype association score is based on knowledge resident in one or more biomedical ontologies.

135. The method of claim 125, wherein said risk score is a genomic risk score.

136. The method of claim 125, wherein said outputting comprises providing a report comprising said list of prioritized phenotypes.

137. The method of claim 125, further comprising providing a therapeutic intervention subsequent to outputting said list of prioritized phenotypes.

138. The method of claim 137, wherein said therapeutic invention comprises treating or monitoring said subject for at least a subset of said two or more phenotypes.

139. The method of claim 138, wherein said two or more phenotypes comprise a disease, and wherein said therapeutic invention comprises treating or monitoring said subject for said disease.

140. The method of claim 125, wherein determining said phenotype association score further comprises including an interaction term, wherein a presence of one or more genome sequence variants in a first gene or genomic region in conjunction with a presence of one or more genome sequence variants in a second gene or genomic region provides a risk score that is different from the sum of the risk scores of genome sequence variants in said first gene or genomic region and said second gene or genomic region alone.

141. The method of claim 140, wherein said interaction between said presence of one or more genome sequence variants in a first gene or genomic region with said presence of one or more genome sequence variants in said second gene or genomic region causes said subject to have an increased risk score for each of said two or more phenotypes.

142. The method of claim 140, wherein said interaction between said presence of one or more genome sequence variants in a first gene or genomic region with said presence of one or more genome sequence variants in said second gene or genomic region causes said subject to have an decreased risk score for each of said two or more phenotypes.

143. The method of claim 125, further comprising determining said risk score by determining a combined score indicative of a probability that said genes or genomic regions as a whole are in a disease state and a combined score indicative of a probability that said genes or genomic regions as a whole are in a healthy state, and wherein said risk score is related to a ratio of said combined score indicative of a probability that said genes or genomic regions as a whole are in said healthy state and said combined score indicative of a probability that said genes or genomic regions as a whole are in said disease state.

144. The method of claim 143, wherein said risk score is normalized to an expected risk score to provide a normalized risk score.

145. The method of claim 144, wherein said normalized risk score is used to compare risk scores between individuals of different genetic backgrounds, and wherein said different genetic backgrounds are different ethnicities.

146. The method of claim 144, wherein said normalized risk is used to rank risk scores of different phenotypes.

147. The method of claim 144, wherein a set of normalized risk scores are determined for a cohort of healthy individuals to provide a population distribution of normalized risk scores.

148. The method of claim 147, wherein said normalized risk score of said subject is compared to said population distribution of normalized risk scores to determine a deviation of said subject's risk score from said population distribution of normalized risk scores.

149. The method of claim 148, wherein said deviation is determined relative to a mean of the population distribution of normalized risk scores.

150. The method of claim 149, wherein said normalized risk score is calculated for each individual in a cohort of individuals with a given phenotype and a cohort of individuals without a given phenotype.

151. The method of claim 125, wherein said two or more phenotypes are common diseases or rare diseases.
